(19) United States
(12) Patent Application Publication
(10) Pub. No.: US 2011/0104425 A1
(43) Pub. Date: May 5, 2011

(54) Folding Cutting Mat

(76) Inventor: Tsai-Lian CHEN LIN, Huatan Township (TW)

(21) Appl. No.: 12/612,671

(22) Filed: Nov. 4, 2009

(51) Int. Cl. B32B 3/02

(52) U.S. Cl. 428/58

(57) ABSTRACT

A folding cutting mat comprises two cut-resistant working surfaces, at least one bendable connecting member and two anti-slip pads that are adhered to one another. Since each of the anti-slip pads has a thickness reduced from one edge toward the opposite edge, after being oppositely combined together, the respective connecting edges of the cut-resistant working surfaces can produce a downward bending force to make the two cut-resistant workings surfaces connect more closely and make the connected cut-resistant working surfaces more flat. The bendable connecting member connected between the two cut-resistant working surfaces includes a concave portion, along which the bendable connecting member is bent. The concave portion is defined with plural spaced through holes and two notches to provide a releasing space for the folds caused by bending deformation, and the bendable connecting member is further embedded with a fiber mesh to increase the durability of the bendable connecting member.

### BACKGROUND OF THE INVENTION

1. Field of the Invention

The present invention relates to an office product or a stationery product; and more particularly to a folding cutting mat.

2. Description of the Prior Art

With the development of industry and improvement of life quality, many products capable of improving working efficiency or convenience are consequentially developed on the market, such as the cutting mat which is used to protect the desk surface while cutting operation is performed. Referring to FIGS. 1 and 2, a conventional folding cutting mat 10 comprises a cutting surface 11, a fiber mesh 12 and two bottom pads 13 that are successively adhered to one another. The cutting surface 11 is used for the user to perform the cutting operation on it. The fiber mesh 12 is connected to the cutting surface 11 and can deform slightly while the cutting mat 10 is bent, so that the cutting mat 10 can be folded and unfolded for facilitating storage and use.

However, after a long time use of the folding cutting mat 10, the cutting surface 11 will be folded for many times, so that on the folding position of the cutting surface 11 will be formed an uneven fold X which is prone to adversely affecting the cutting accuracy and more prone to causing damage or fracture, thus leading to inconvenience in use.

The present invention has arisen to mitigate and/or obviate the afore-described disadvantages.

### SUMMARY OF THE INVENTION

The primary objective of the present invention is to provide a folding cutting mat which can be bent effortlessly and can keep the working surfaces flat in use and improve the use convenience.

In order to achieve the above objective, a folding cutting mat in accordance with the present invention comprises: two cut-resistant working surfaces, at least one bendable connecting member, and two anti-slip pads.

The two cut-resistant working surfaces each include a connecting edge, and the two connecting edges of the two cut-resistant working surfaces can be oppositely combined.

The bendable connecting member is connected to both bottoms of the two cut-resistant working surfaces and defined with a notch in each of two opposite ends thereof.

The two anti-slip pads are adhered to the bottoms of the respective cut-resistant working surfaces and located at both sides of the bendable connecting member, one edge of each of the two anti-slip pads, which is located adjacent to the bendable connecting member, has a first thickness, and the other edge opposite the edge having the first thickness has a second thickness, and the second thickness is greater than the first thickness.

Due to the thickness difference of the anti-slip pads, the thickness of the two connected cut-resistant working surfaces reduces from both sides toward a center, and the connecting edges of the two cut-resistant working surfaces can produce a downward bending force to make the cut-resistant working surfaces connect more closely, ensuring the working surface for cutting more flat. The notches of the bendable connecting member provide a releasing space for the compression fold caused by bending deformation to make the bending operation smoother and more effortless. The fiber mesh in the bendable connecting member enables the bendable connecting members to be easily bendable and improves the durability of the bendable connecting members, extending the service life of the cutting mat.

### BRIEF DESCRIPTION OF THE DRAWINGS

FIG. 1 is an exploded view of a conventional folding cutting mat;

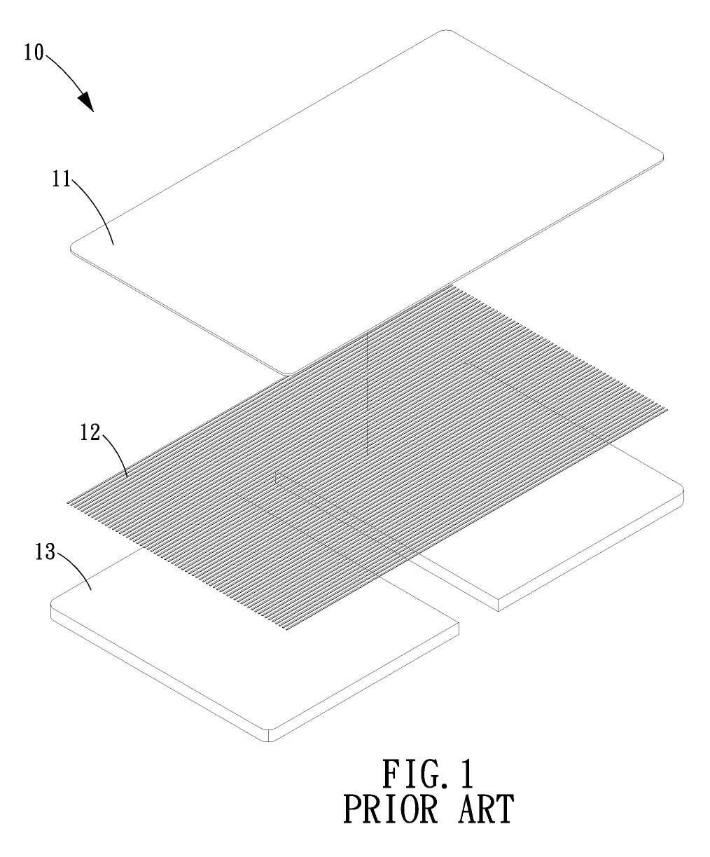

FIG. 2 is an enlarged view showing that the conventional folding cutting mat is folded;

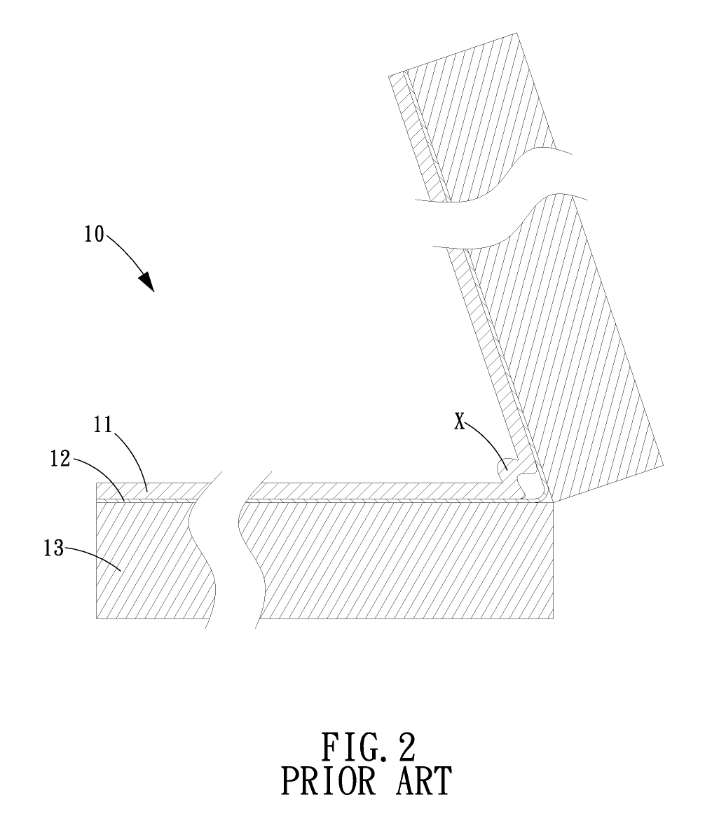

FIG. 3 is an exploded view of a folding cutting mat in accordance with the present invention;

FIG. 4 is a perspective view of the folding cutting mat in accordance with the present invention;

FIG. 5 is an assembly view of the folding cutting mat in accordance with the present invention;

FIG. 6 is a cross-sectional view of the folding cutting mat in accordance with the present invention;

FIG. 7 is a partial enlarged view of FIG. 6;

FIG. 8 is a partial cross-sectional view of the folding cutting mat in accordance with the present invention;

FIG. 9 is an operational view showing that the folding cutting mat in accordance with the present invention is bent;

FIG. 10 is another operational view showing that the folding cutting mat in accordance with the present invention is bent;

FIG. 11 is a perspective view showing that the folding cutting mat in accordance with the present invention comprises two bendable connecting members;

FIG. 12 is a plane view showing that the connecting edges of the two cut-resistant working surfaces are irregular wavy edges;

FIG. 13 is an exploded view showing that the folding cutting mat in accordance with the present invention comprises only one bendable connecting member; and

FIG. 14 is an operational view of the folding cutting mat of FIG. 13.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

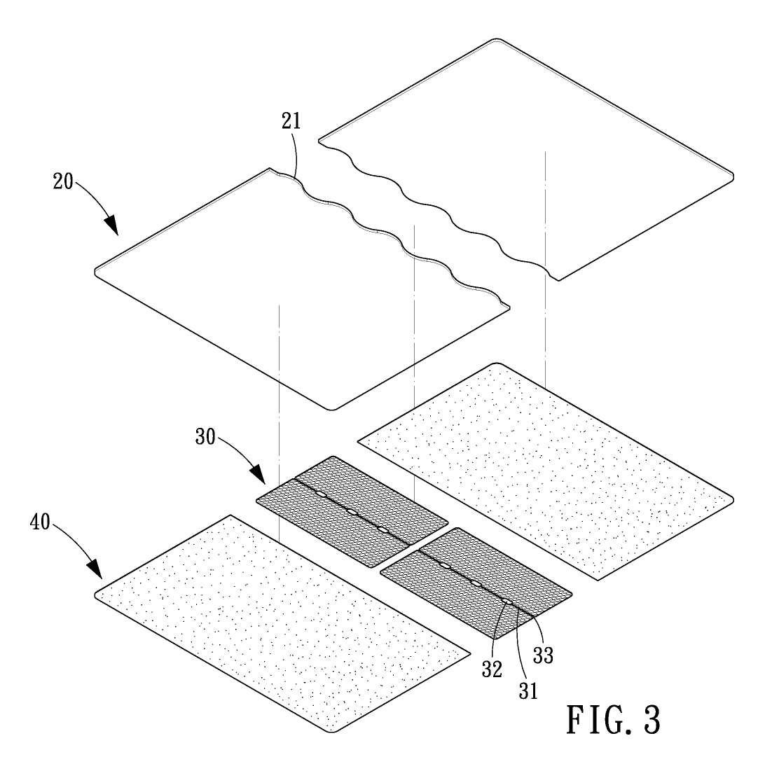

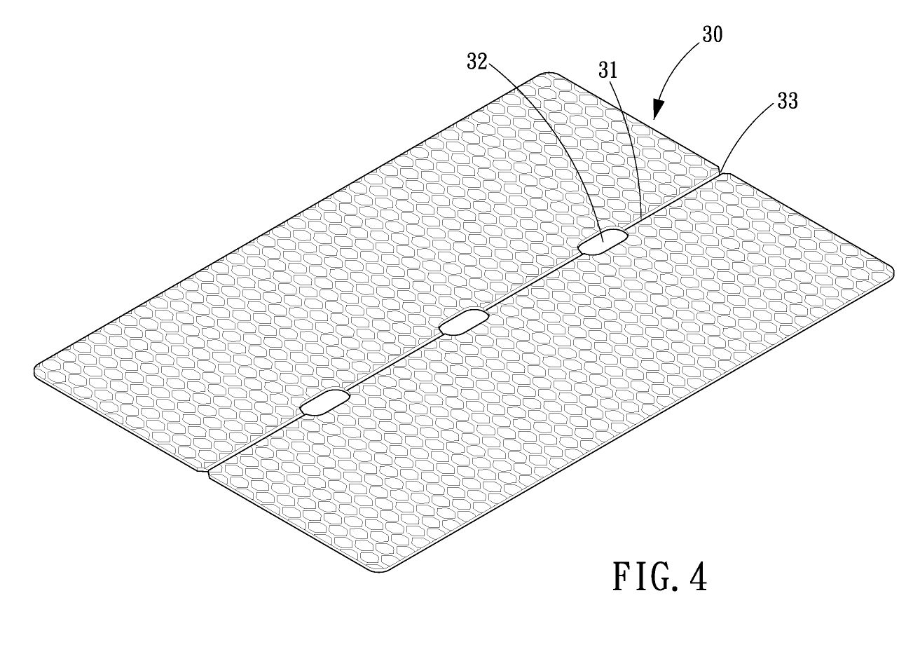

Referring to FIGS. 3-10, a folding cutting mat in accordance with a first embodiment of the present invention comprises two cut-resistant working surfaces 20, at least two bendable connecting members 30, and two anti-slip pads 40.

Each of the two cut-resistant working surfaces 20 includes a regular wavy connecting edge 21, and the connecting edges 21 of the two cut-resistant working surfaces 20 can be oppositely combined together to make the two cut-resistant working surfaces 20 form a complete rectangular plate structure. The respective cut-resistant working surfaces 20 have a surface layer made of soft material.

The at least two bendable connecting members 30 each are embedded with a fiber mesh. The bendable connecting members 30 are spaced from each other and connected to both bottoms of the two cut-resistant working surfaces 20 by means of gluing, ultrasound or high-frequency wave, so that the two bendable connecting members 30 are located between the two cut-resistant working surfaces 20 to connect the two cut-resistant working surfaces 20 together. Each of the bendable connecting members 30 includes a concave portion 31 along a central line thereof, and the bendable connecting members 30 are bent along the respective concave portions 31. Each of the concave portions 31 is defined with plural spaced through holes 32. In each of two opposite ends of each of the concave portions 31 is further defined a notch 33.

The two anti-slip pads 40 are adhered to the bottoms of the respective cut-resistant working surfaces 20 and located at both sides of the respective bendable connecting members 30. One edge of each of the anti-slip pads 40, which is located adjacent to the bendable connecting members 30, has a first thickness D1 while the other edge opposite to the edge having the first thickness D1 has a second thickness D2. The second thickness D2 is greater than the first thickness D1, so that after the two cut-resistant working surfaces 20 are oppositely combined together, the thickness of the folding cutting mat of the present invention will reduce from both sides toward a center thereof.

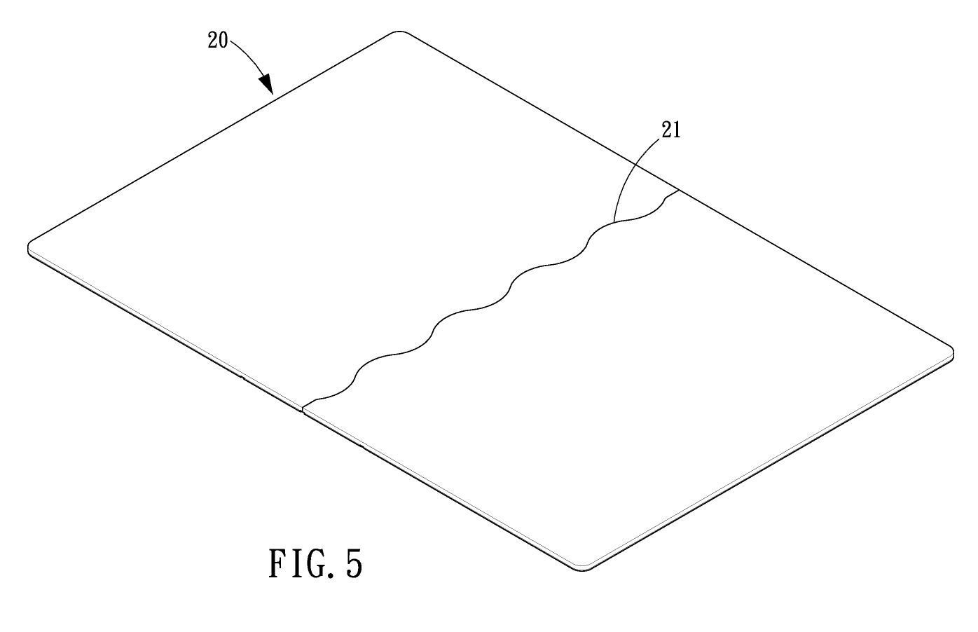

The aforementioned is the summary of the positional and structural relationship of the respective components of the folding cutting mat in accordance with the first embodiment of the present invention. When the connecting edges 21 of the two cut-resistant working surfaces 20 are oppositely combined, since the connecting edges 21 are wavy, the connecting area is increased. Due to the increase of the connecting area, the two cut-resistant working surfaces 20 are connected more closely, thus making the connected cut-resistant working surfaces 20 more flat, as shown in FIG. 5, to keep the cutting accuracy.

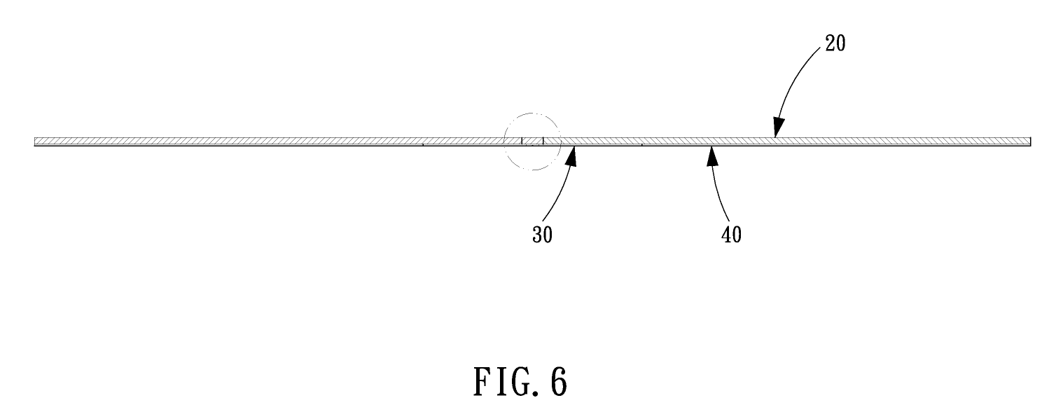

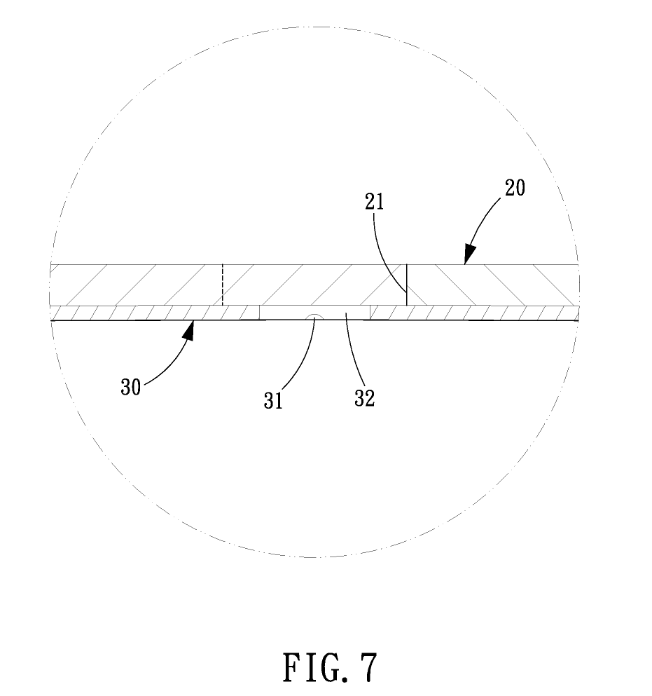

When folding the cutting mat, the user can bend the two cut-resistant working surfaces 20, at this moment, the force applying on the bendable connecting members 30 connected between the two cut-resistant working surfaces 20 can be diffused due to the embedded fiber meshes in the respective bendable connecting members 30, thus effectively improving the strength and the durability of the bendable connecting members 30 and enabling the bendable connecting members 30 to be easily bendable, and as a result of this, the bendable connecting members 30 can be bent frequently without being broken, thus extending the service life of the bendable connecting members 30. Further since the respective bendable connecting members 30 have the concave portion 31 along the central line thereof, as shown in FIGS. 6 and 7, the cut-resistant working surfaces 20 will be bent along the concave portions 31 which can make the bending operation smoother and more effortless. In addition, the respective bendable connecting members 30 are further defined with the through holes 32 and the notches 33, and these through holes 32 and the notches 33 can provide a releasing space for the compression folds caused by bending deformation of the bendable connecting members 30, reducing the occurrence of the compression fold while making the bending operation more effortless.

Furthermore, since the respective bendable connecting members 30 are defined with the spaced through holes 32, the spaced through holes 32 can prevent the bendable connecting members 30 from being further broken even if the bendable connecting members 30 might be broken after many times of use. Therefore, the through holes 32 can avoid fracture and extend the service life of the bendable connecting members 30 while increasing the durability of the cutting mat of the present invention.

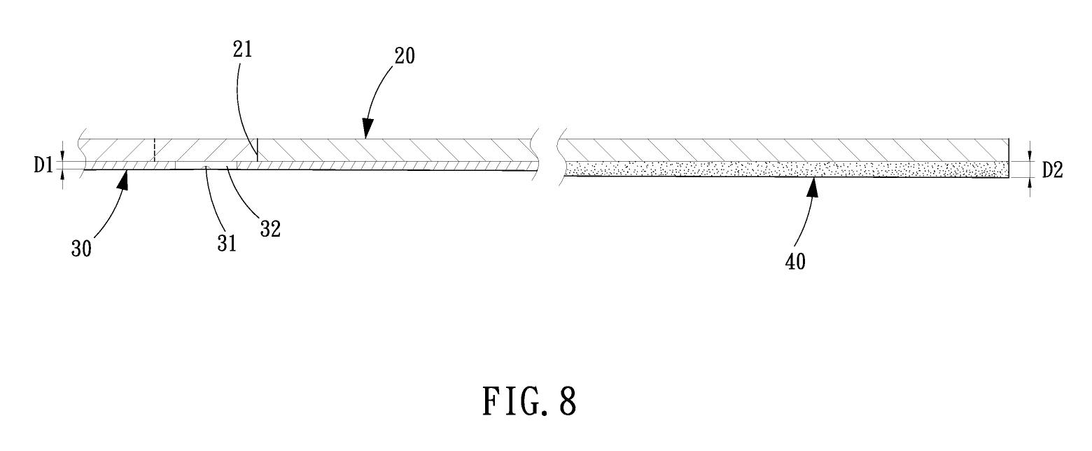

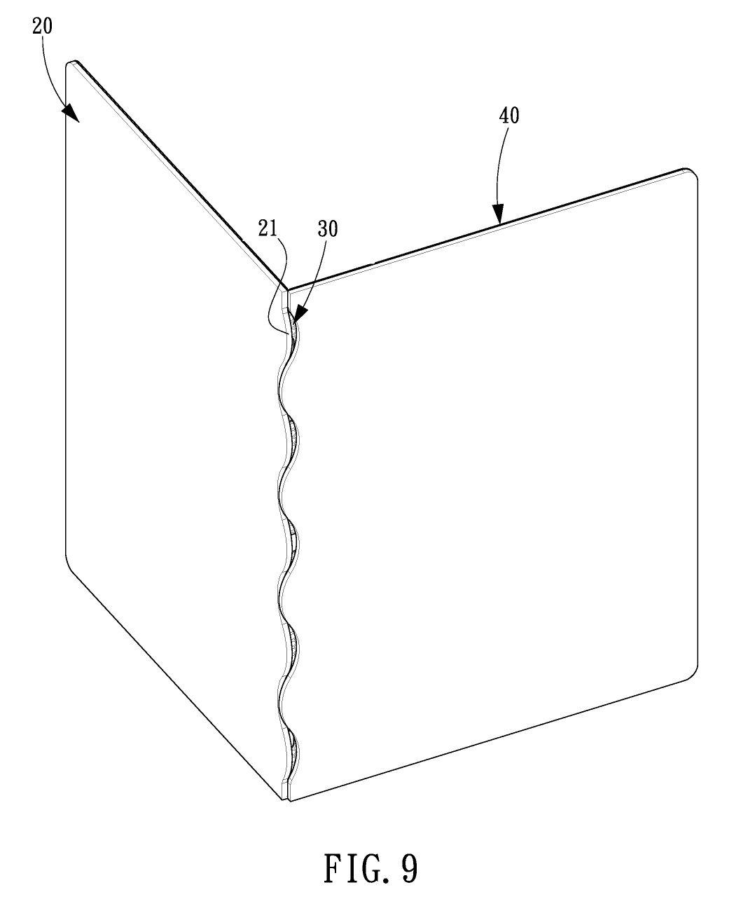

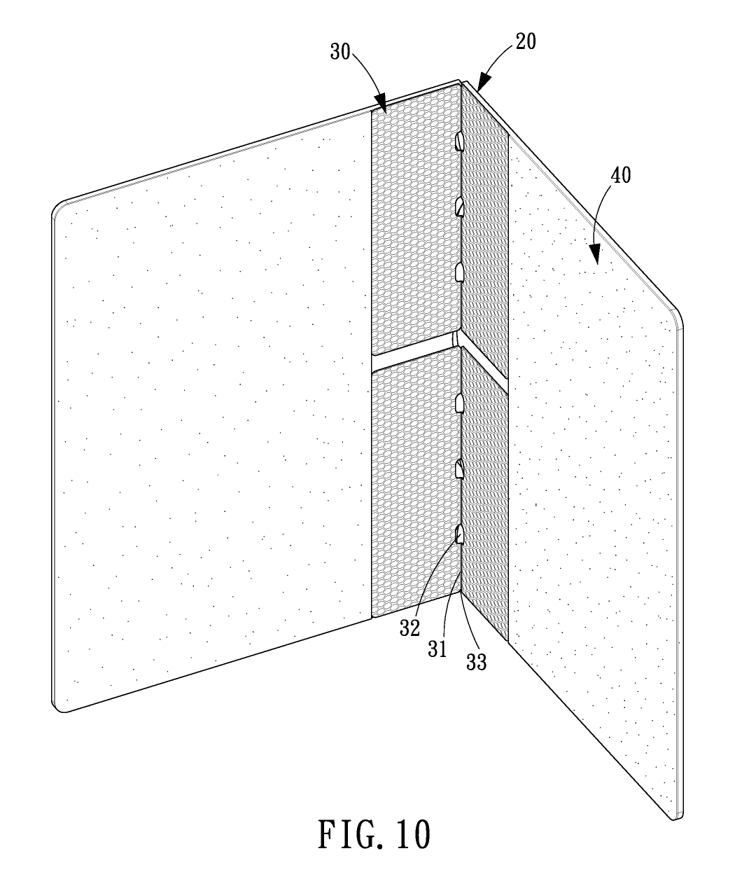

Further referring to FIG. 8, after the two cut-resistant working surfaces 20 are oppositely combined, due to the thickness difference of the anti-slip pads 40, the thickness of the cutting mat of the present invention reduces from both sides toward the centre, so that the middle portion of the cutting mate is slightly concave toward the center to produce a downward bending force which further cooperate with the soft material of the surface layers of the respective cut-cut working surfaces 20 to make the two cut-resistant working surfaces 20 slightly concave toward the two centrally-arranged connecting edges 21. When the cutting mat of the present invention is bent, the two cut-resistant working surfaces 20 are bent toward the respective opposite bendable connecting members 30, as shown in FIGS. 9 and 10, so that the bending force produced by the two cut-resistant working surfaces 20 is opposite to the bending direction of the two cut-resistant working surfaces 20, that is to say, the bending force of the two cut-resistant working surfaces 20 toward the respective connecting edges 21 will make the connecting edges 21 of the two cut-resistant working surfaces 20 connect more closely and further make the cutting working surfaces 20 more flat, thus increasing the use convenience and cutting accuracy.

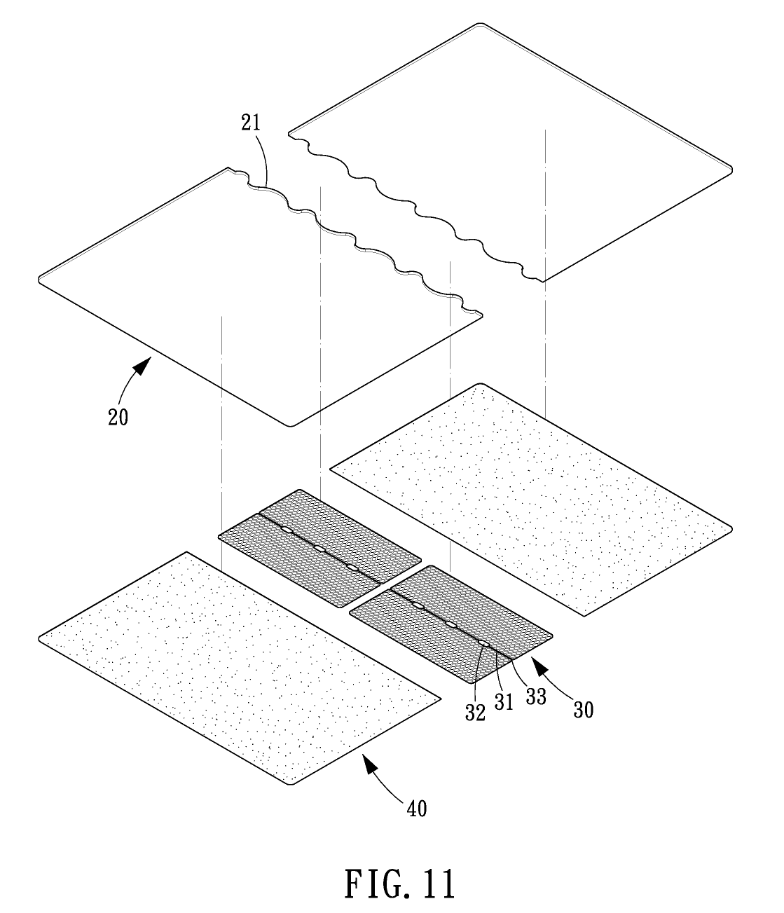

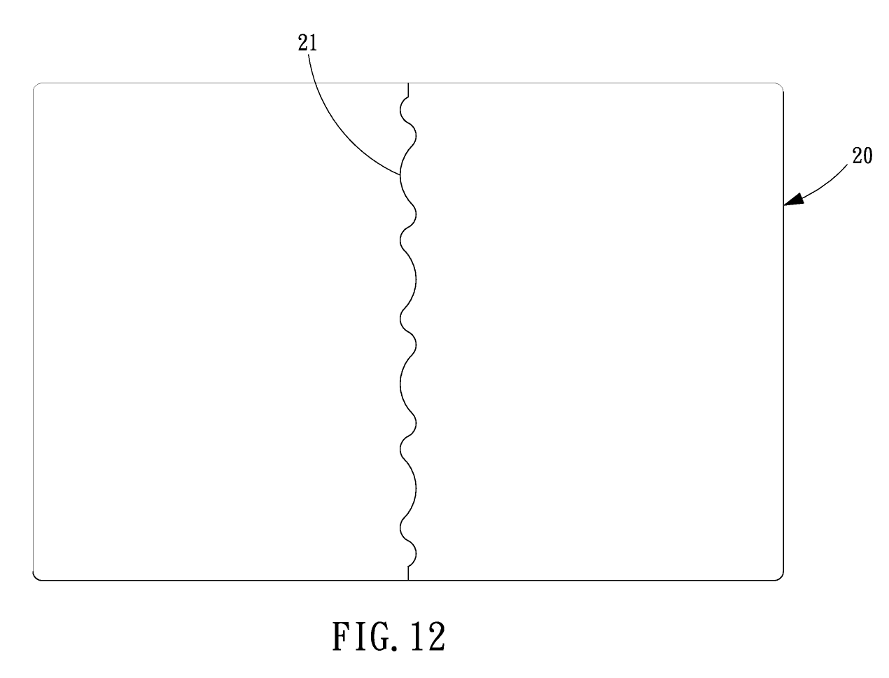

Referring to FIGS. 11 and 12 which illustrate a folding cutting mat in accordance with a second embodiment of the present invention, each of the two cut-resistant working surfaces 20 includes an irregular wavy connecting edges 21 which can further increase the connecting area and the connecting closeness of the two cut-resistant working surfaces 20, making the connected cut-resistant working surfaces 20 more flat, of course, the cutting mat in the present embodiment can also realize the same functions as described above.

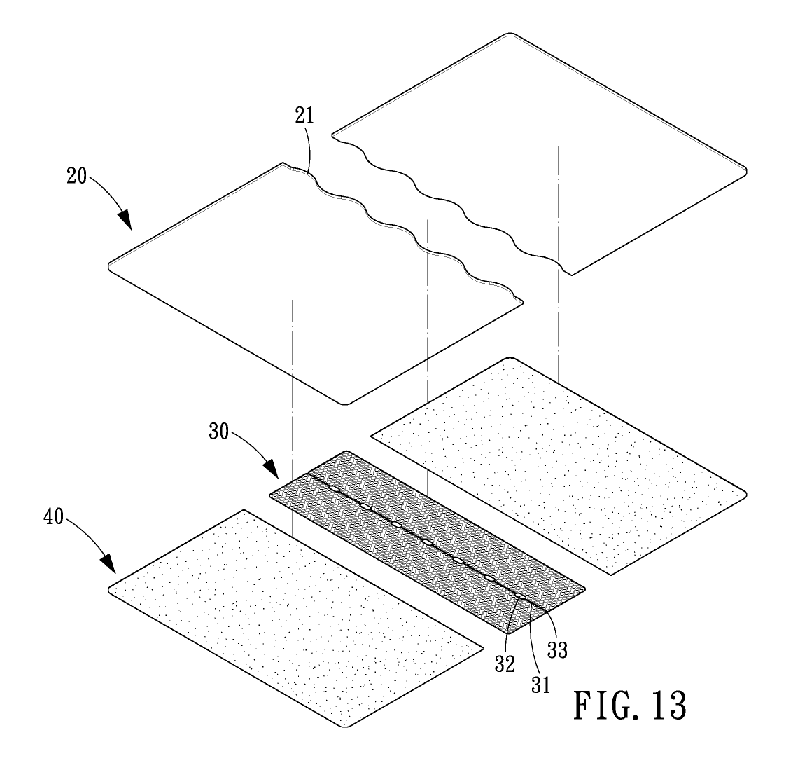

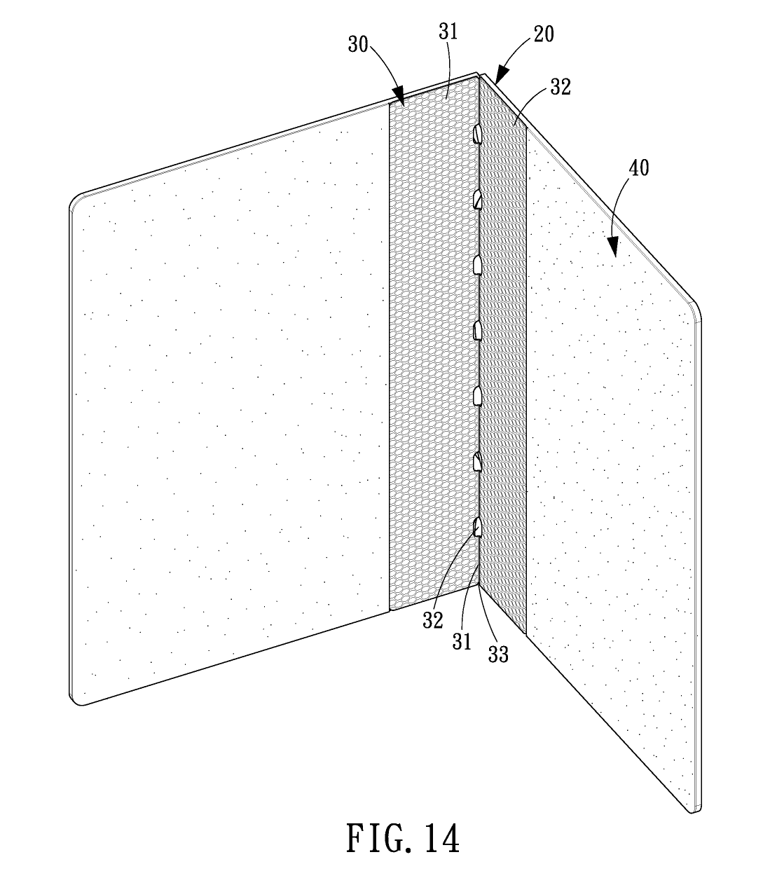

Referring to FIGS. 13 and 14 which illustrate a folding cutting mat in accordance with a third embodiment of the present invention, the cutting mat in accordance with the present embodiment of the present invention is provided with only one bendable connecting member 30 to realize the same functions as described above.

While we have shown and described various embodiments in accordance with the present invention, it is clear to those skilled in the art that further embodiments may be made without departing from the scope of the present invention.

What is claimed is:

1. A folding cutting mat comprising:
two cut-resistant working surfaces each including a connecting edge, and the two connecting edges of the two cut-resistant working surfaces being allowed to be oppositely combined;
at least one bendable connecting member being connected to both bottoms of the cut-resistant working surfaces, the bendable connecting member being defined with a notch in each of two opposite ends thereof; and
two anti-slip pads being adhered to the bottoms of the respective cut-resistant working surfaces and located at both sides of the bendable connecting member, one edge of each of the two anti-slip pads, which is located adjacent to the bendable connecting member, having a first thickness, and the other edge opposite the edge having the first thickness having a second thickness, and the second thickness being greater than the first thickness.

2. The folding cutting mat as claimed in claim 1, wherein the connecting edges of the respective cut-resistant working surfaces are regular wavy connecting edges, and the two cut-resistant working surfaces are oppositely combined to each other to form a complete rectangular plate structure.

3. The folding cutting mat as claimed in claim 1, wherein the bendable connecting member is connected to the respective cut-resistant working surfaces by means of gluing, ultrasound or high-frequency wave.

4. The folding cutting mat as claimed in claim 1, wherein the bendable connecting member is defined with a concave portion along a central line thereof, and the bendable connecting member is bent along the concave portion.

5. The folding cutting mat as claimed in claim 4, wherein the concave portion of the bendable connecting member is defined with plural spaced through holes.

6. The folding cutting mat as claimed in claim 1, wherein the connecting edges of the respective cut-resistant working surfaces are irregular wavy connecting edges, and the two cut-resistant working surfaces are oppositely combined to each other to form a complete rectangular plate structure.

7. The folding cutting mat as claimed in claim 1, wherein the bendable connecting member is embedded with a fiber mesh.

8. The folding cutting mat as claimed in claim 1, wherein the cutting mat comprises two bendable connecting members, and the two bendable connecting members are spaced from each other and connected to the respective cut-resistant working surfaces.
